(19) United States
(12) Patent Application Publication
(10) Pub. No.: US 2013/0013505 A1
(43) Pub. Date: Jan. 10, 2013

(54) TRANSACTION ENGINE REMOTE CONTROL

(75) Inventor: Matthew K. Bryant, Gastonia, NC (US)

(73) Assignee: Bank of America, Charlotte, NC (US)

(21) Appl. No.: 13/178,608

(22) Filed: Jul. 8, 2011

(51) Int. Cl. G06Q 40/00

(52) U.S. Cl. 705/44; 705/35

(57) ABSTRACT

Apparatus and methods for controlling account access. The apparatus may include a receiver that is configured to receive from a customer an account access control instruction. The account access control instruction may change an access status of an account that holds funds belonging to the customer. The customer may be one of a plurality of customers of a financial institution. Each of the customers may own funds that are held in different accounts. The apparatus may include a processor. The processor may initialize an account access control program; and change the access status of the account between an activated state and a deactivated state. The processor may change the access status by transmitting a data object to an electronic payment platform.

### FIELD OF TECHNOLOGY

This application relates to controlling account access. More specifically, the application relates to issuance of instructions to activate or deactivate an account.

### BACKGROUND OF THE INVENTION

Financial institutions typically provide to a customer activation and deactivation services in connection with a banking card.

FIG. 1 shows typical credit card activation/deactivation flow 100. At step 1, the customer contacts a financial institution call center to activate or deactivate a credit card. At step 2, the call center initiates a transaction in a debit card system such as an electronic fund transfer at point of sale (“EFTPOS”) system. At step 3, the debit card system sends an activation or a deactivation flag to a host system such an authorization engine. The flag may be included in a card access file (“CAF”). At step 4, the host system receives the flag. At step 5, an electronic payment platform is updated based on the flag. At step 6, the electronic payment platform updates and the credit card is activated or deactivated.

The customer typically does not have control over a level, type or timing of activity for which the card may be used.

It would be desirable, therefore, to provide apparatus, methods and media for a customer to control account access.

### SUMMARY OF THE INVENTION

Apparatus and methods for controlling account access. The apparatus may include a receiver that is configured to receive from a customer an account access control instruction. The account access control instruction may change an access status of an account that holds funds belonging to the customer. The customer may be one of a plurality of customers of a financial institution. Each of the customers may own funds that are held in different accounts. The apparatus may include a processor. The processor may initialize an account access control program; and change the access status of the account between an activated state and a deactivated state. The processor may change the access status by transmitting a data object to an electronic payment platform.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a prior art process;

FIG. 2 shows an illustrative system in accordance with the principles of the invention;

FIG. 3 shows illustrative apparatus in accordance with the principles of the invention;

FIG. 4 shows other illustrative apparatus in accordance with the principles of the invention;

FIG. 5 shows illustrative elements of a process in accordance with the principles of the invention;

FIG. 6 shows illustrative elements of another process in accordance with the principles of the invention; and

FIG. 7 shows illustrative elements of yet another process in accordance with the principles of the invention.

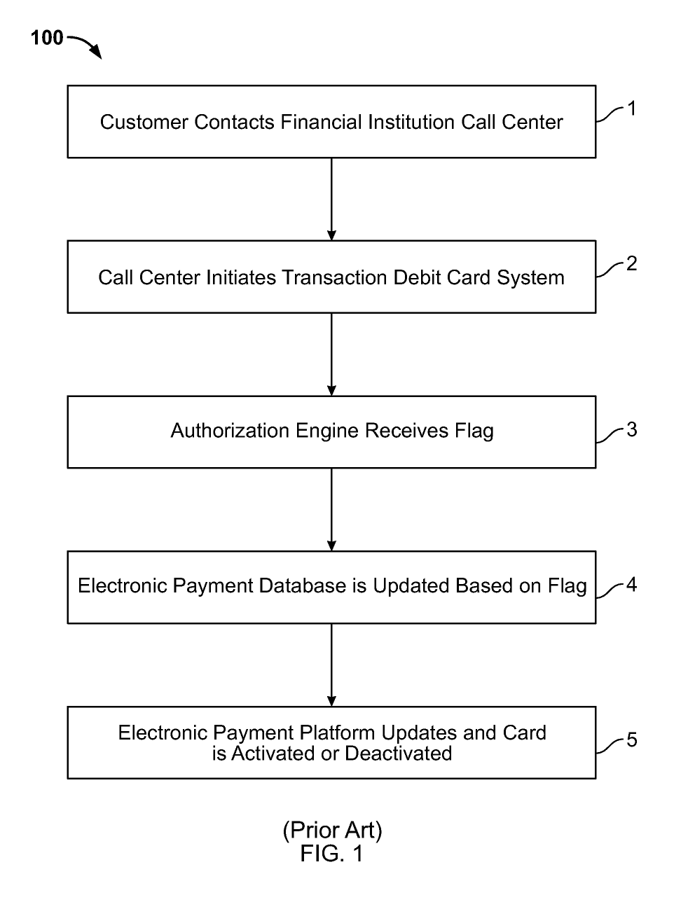

### DETAILED DESCRIPTION OF THE INVENTION

Apparatus, methods and media for controlling account access are provided. The apparatus may include, and the methods or media may involve, a receiver that may receive from a customer an account access control instruction. The account access control instruction may change an access status of an account. The account may hold funds that belong to the customer. The customer may be one of a plurality of customers of a financial institution. Each customer may own funds that are held in different accounts. The apparatus may include, and the methods may involve a processor that may initialize an account access control program. The processor may change the access status of the account. The access status may be “ACTIVATED.” The access status may be “DEACTIVATED.”

The apparatus, methods or media may be used to provide a service to the customer. The customer may use the service for any suitable purpose. For example, the customer may use the service to deactivate a transaction instrument. The customer may activate the transaction instrument as needed. The customer may activate and deactivate the transaction instrument via web, mobile, phone, banking center or any other suitable financial institution channel.

For example, the customer may maintain the transaction instrument in a deactivated state and, using a mobile device, such as a cell phone, activate the transaction instrument while waiting to pay for goods or services in a cash register check-out line. The customer may execute a transaction at the cash register and then deactivate the transaction instrument after completing the transaction.

For example, if the transaction instrument is lost or stolen, the customer may easily deactivate the transaction instrument. If the customer finds the transaction instrument, the customer may activate the transaction instrument.

For example, the customer may use the service to provide the transaction instrument to a child or other dependent. The customer may activate the transaction instrument only when the child or dependent needs or requests access to the account. For example, the customer may activate the transaction instrument for a designated transaction and then disable the transaction instrument after the transactions.

The apparatus may include, and the methods or media may involve, a transmitter that may change the access status by transmitting a data object to an electronic payment platform.

The account access control instruction may include an access switch. The switch may switch the access status between two or more different values. The switch may toggle the access status between “ACTIVATED” AND “DEACTIVATED.”

The transmitter may transmit account access control feedback to the customer. The account access control feedback may identify a transaction or attempted transaction. The account access control feedback may include account status corresponding to the transaction or attempted transactions. The account access control feedback may include a transaction outcome corresponding to the transactions or attempted transaction. The transaction outcome may be “TRANSACTION SUCCESSFULLY COMPLETED,” “TRANSACTION DENIED,” or any other suitable transaction outcome.

The account access control instruction may include a temporal constraint. The temporal constraint may be based on a period of time. The temporal constraint may be based on a start date. The temporal constraint may be based on an end date.

The account access control instruction may include a payee constraint. The payee constraint may identify a payee with whom a transaction is to be completed. The payee constraint may identify a payee with whom the transaction is to be denied. The payee may be identified by one or more of the payee's name, address, email address, world wide web domain name, on-line bill-pay identification number, routing number or any other suitable identification information.

The account access control instruction may include a check number. The check number may identify a check. The account access control instruction may set the account status with respect to a check having the check number. For example, the account access control instruction may deactivate the account with respect to check number XYZ to cancel payment on check XYZ if check XYX is presented to the financial institution for payment.

The account access control instruction may include an amount. The amount may be a minimum amount. For example, the account access control instruction may require that payment to an identified payee be made in an amount that is at least the minimum amount. The amount may be a maximum amount. For example, the account access control instruction may require that payment to an identified payee be made in an amount that is no more than the maximum amount. The amount may be included in a range of amounts. For example, the range may require that payment to any payee be made in an amount that is within the range of amounts.

Table 1 shows illustrative examples of account access control instructions.

TABLE 1
Illustrative Instruction Table.

| Instruction | | Instruction | Instruction |
|---|---|---|---|
| ID | Instruction Type | Parameter ID | Parameters |
| 1 | Switch | 1 | ACTIVATE |
| | | 2 | DEACTIVATE |
| 2 | Series | 1 | Enter Number of |
| | | | Transactions |
| 3 | Limited activation | 1 | Enter n days |
| | period, beginning now | 2 | Enter o hours |
| | | 3 | Enter p minutes |
| 4 | Future period | 1 | Enter Start |
| | | | Date |
| | | 2 | Enter End Date |
| 5 | Vendor-constrained | 1 | Payee 1 |
| | | 2 | Payee 2 |
| | | . . . | . . . |
| | | P | Payee P |
| 6 | Amount-constrained- | 1 | $100.00 |
| | maximum | 2 | $250.00 |
| | | 3 | $500.00 |
| | | . . . | . . . |
| | | M | Enter Maximum |
| | | | Amount |
| 7 | Amount-constrained- | 1 | $100.00 |
| | minimum | 2 | $250.00 |
| | | 3 | $500.00 |
| | | . . . | . . . |
| | | N | Enter Minimum |
| | | | Amount |
| 8 | Amount-constrained- | 1 | Enter Range |
| | range | | Minimum |
| | | 2 | Enter Range |
| | | | Maximum |
| 9 | Check-number-selected | 1 | Enter number of |
| | | | check to be |
| | | | honored |
| | | 2 | Enter |
| | | | subsequent |
| | | | consecutive |
| | | | number of |
| | | | checks to honor |
| | | 3 | Enter number of |
| | | | check for which |
| | | | to stop payment |
| | | 4 | Enter |
| | | | subsequent |
| | | | consecutive |
| | | | number of |
| | | | checks to stop |
| | | | payment |

The customer may program Instruction No. 5 parameters 1 . . . P to correspond to payees that the customer may choose.

The customer may issue one or more account access control instructions in an instruction set. For example, the customer may issue as an instruction set such as illustrative instruction set A, shown in Table 2:

TABLE 2
Illustrative Instruction Set A.

| Selected | | Selected | |
|---|---|---|---|
| Instruction | | Instruction | Instruction |
| ID | Selected Instruction | Parameter ID | Parameters |
| 1 | Switch | 2 | DEACTIVATE |
| 4 | Future period | 1 | May 1, 2011 |
| | | 2 | May 14, 2011 |
| 5 | Vendor-constrained | 2 | Payee B |

In Instruction Set A, Instruction No. 1 may deactivate the account during a period (May 1, 2011 to May 14, 2011) that is defined by Instruction No. 4 for any transactions that are attempted between the customer and Payee B.

The customer may issue a “toggle” instruction in an instruction set. For example, the customer may issue a toggle instruction set such as illustrative instruction set B, shown in Table 3:

TABLE 3
Illustrative Instruction Set B.

| Selected | | Selected | |
|---|---|---|---|
| Instruction | | Instruction | Instruction |
| ID | Selected Instruction | Parameter ID | Parameters |
| 1 | Switch | 2 | DEACTIVATE |

In Instruction Set B, Instruction No. 1 may deactivate the account. Instruction No. 1 may deactivate the account until a subsequent instruction set is issued.

The customer may issue a “series” instruction in an instruction set. For example, the customer may issue a toggle instruction set such as illustrative instruction set C, shown in Table 4:

TABLE 4
Illustrative Instruction Set C.

| Selected | | Selected | |
|---|---|---|---|
| Instruction | | Instruction | Instruction |
| ID | Selected Instruction | Parameter ID | Parameters |
| 1 | Switch | 2 | ACTIVATE |
| 2 | Series | 1 | 3 |

In Instruction Set C, Instruction No. 1 may activate the account. Instruction No. 2 may keep Instruction No. 1 in effect for a series of three transactions. After the third transaction, the account may return to its previous status. The previous status may be a default status. The default status may be DEACTIVATED. The default status may be governed by a previous instruction set.

The customer may set an instruction set as a default status. The customer may select whether the account returns, after completion of an instruction set, to the default status or a status determined by a previous instruction set.

The customer may issue instructions that identify checks by number, series or range an instruction set. For example, the customer may issue a check-declining instruction set such as illustrative instruction set D, shown in Table 5:

TABLE 5
Illustrative Instruction Set D.

| Selected | | Selected | |
|---|---|---|---|
| Instruction | | Instruction | Instruction |
| ID | Selected Instruction | Parameter ID | Parameters |
| 9 | Check-number-selected | 3 | 2100 |
| | | 4 | 2 |

In Instruction Set D, Instruction No. 9, Parameter No. 3, may request a stop on payment of customer check no. 2100. Parameter No. 4 may request a stop payment of two subsequent consecutive checks (2101 and 2102).

The customer may issue the instruction set using a user interface of any suitable customer access device. The interface may provide a graphic form for selecting instructions. The interface may include an interactive voice response (“IVR”) system for receiving an instruction set based on the customer's voice or keypad entries. The customer may interact with the IVR system using a programmed sequence that is delivered to the IVR as part of a telephone call that may be initiated by speed dialing.

The IVR may have a logical branch that is configured to receive a sequence of numbers that correspond to one or more of customer identification information, customer authentication information, account information, transaction instrument information, one or more access control instructions, one or more instruction sets or any other suitable information.

The transaction instrument may include any suitable transaction instrument, such as a credit card, debit card, an instrument or device that includes a contactless chip, such as an ISO14443-compliant contactless chip, a paper check, a check-by-phone, an electronic funds transaction (“EFT”) instruction, a virtual debit card, a virtual credit card, a virtual version of any other suitable card for transactions, whether cashless or cash-based or any other transaction instrument or virtual transaction instrument.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

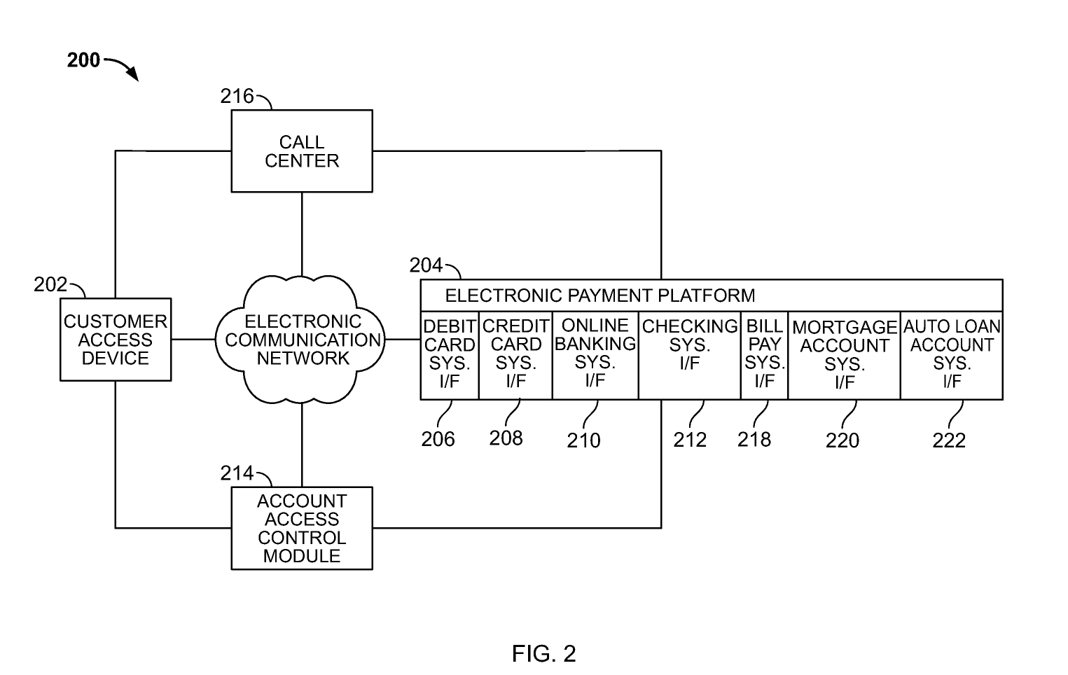

FIG. 2 shows illustrative system 200 for controlling account access. System 200 may include customer access device 202. A customer (customer “C”, e.g., not shown) may use customer access device 202 to activate or deactivate an account that is interfaced to electronic payment platform 204. Electronic payment platform 204 may include one or more of debit card system interface 206, credit card system interface 208, online banking system interface 210, checking system interface 212, bill-pay system 216, mortgage account system interface 220 and auto loan account system interface 222 for interfacing with one or more accounts that customer C may hold at the financial institution.

Customer C may use access device 202 to provide or identify an account access control instruction set to account access control module 214. Account access module 214 may initialize an account access control program that corresponds to the instruction set. The account access control program may transmit ACTIVATE and DEACTIVATE flags to electronic payment platform 204 to activate and deactivate an account in conformance with the account access control program.

Customer C may provide or identify the account access control instruction set to account access control module 214 through a customer service agent at call center 216. Customer C may provide one or more individual account access control instructions to the customer service agent. The customer service agent may transmit ACTIVATE and DEACTIVATE flags that correspond to the instructions to electronic payment platform 204. The flags may activate and deactivate an account in conformance with the account access control instructions.

Customer access device 202 may be a self-service device, such as an ATM, an on-line banking portal, a cell phone or any other suitable device. Customer access device 202 may include one or more devices for authenticating the identity of customer C.

Customer access device 202 may be based on hardware architecture that is similar to a personal computer. Accordingly, many self-service devices are able to use operating systems such as those available under the trademarks WINDOWS (from the MicroSoft Corporation, Redmond, Wash.) or LINUX (from sources such as Linux Online, Inc., Ogdensburg, N.Y.).

Electronic payment platform 204 may include one or more applications such as that available from ACI Worldwide Corp., Omaha, Nebr. under the trademark BASE24, that available from Fiserv, Portland, Oreg., under the trademark ACCEL/Exchange, any of those available from MasterCard Worldwide, Purchase, N.Y., under the trademark MasterCard SPS, or any other suitable transaction-processing platform.

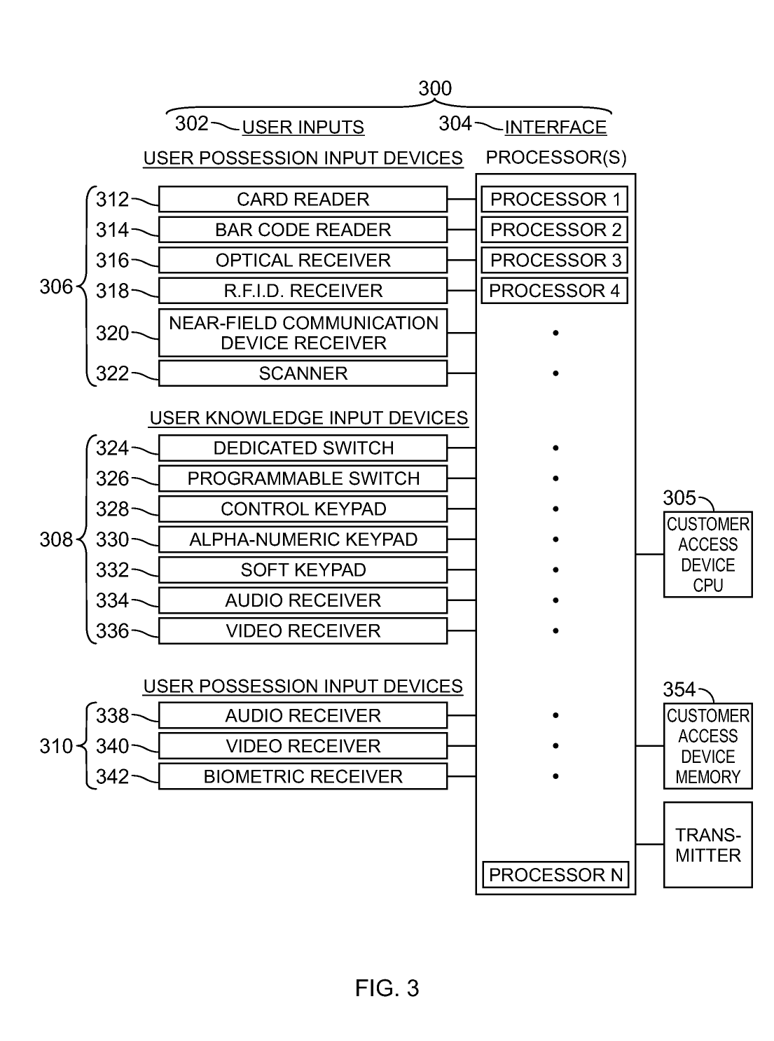

FIG. 3 shows illustrative customer access device data input module 300, which may be used in connection with customer access device 202 (shown in FIG. 2).

Input module 300 may include user input devices 302. User input devices 302 may receive information from customer C. The information may include authentication information, identity information, transaction information, bank account information, account access control information and any other suitable information. Input module 300 may include interface 304. Interface 304 may communicate with user input devices 302 and customer access device CPU 305. Interface 304 may communicate using RS232, XFS, or any other suitable communication protocol. Interface 304 may communicate data in XML, XFML or any other suitable format.

User input devices 302 may include one or more of user possession input devices 306, user knowledge input devices 308, user identity input devices 310 and any other suitable user input devices and devices for inputting any other suitable user information.

User input devices 302 may be used for single- or multifactor user authentication.

User possession input devices 306 may include card reader 312, bar code reader 314, optical receiver 316, R.F.I.D. receiver 318, near-field communication device receiver 320, scanner 322 and any other suitable device for receiving information from a possession of the user.

User knowledge input devices 308 may include dedicated switch 324, programmable switch 326, control keypad 328, alpha-numeric keypad 330, soft keypad 332, audio receiver 334, video receiver 336 and any other suitable device for receiving information from the knowledge of the user.

User identity input devices 310 may include audio receiver 338, video receiver 340, biometric receiver 342 and any other suitable device for receiving information about the body or characteristics of the user.

The user may use one or more of user possession input devices 306, user knowledge input devices 308, and user identity input devices 310 to establish a connection with account access control module 214 (shown in FIG. 2). User possession input devices 306, user knowledge input devices 308 and user identity input devices 310 may be used to communicate authentication and contingency funds information.

Processor array 302 may include one or more processors 1 . . . N. Processors 1 . . . N may include one or more ARM processor, RISC processor, CISC processor, X86 processor, media communications processor (“MCP”), or any other suitable processor or processors.

Customer interface 304 may include or interface with customer access device memory 354. Memory 354 may store account access control information such as one or more of an account access control instruction, an account access control instruction set, transmission or routing information for establishing communication with account access control module 214 (shown in FIG. 2) or any other suitable information.

Customer interface 304 may include or interface with customer access device transmitter 356. Transmitter 356 may be configured to communicate with one or more of call center 216, electronic payment platform 204 and account access control module 214.

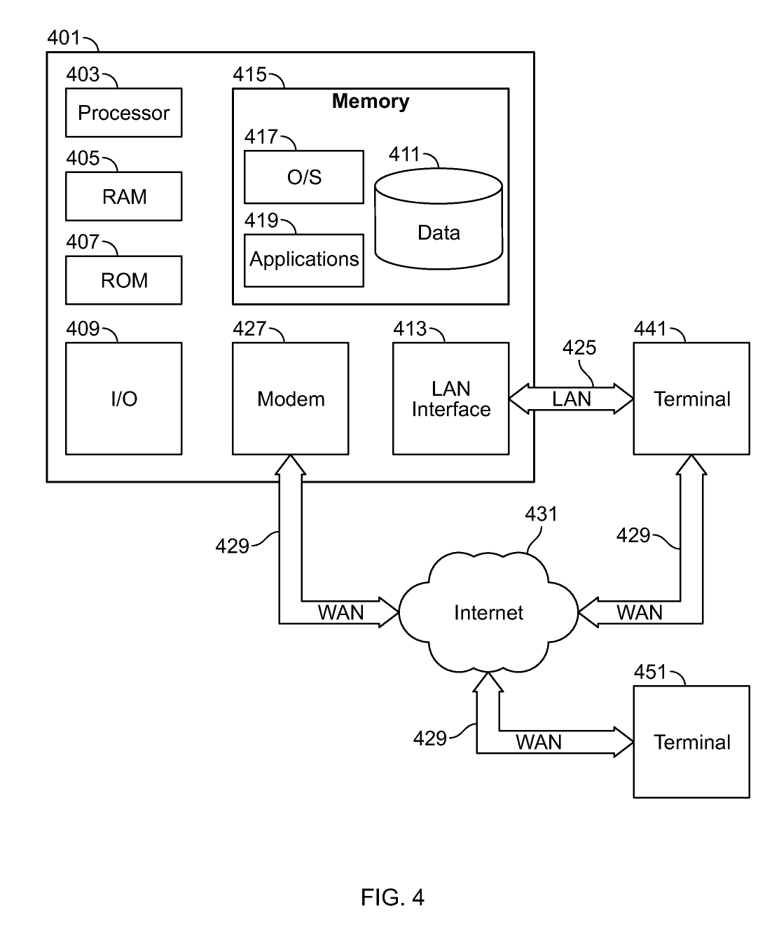

FIG. 4 is a block diagram that illustrates a generic computing device 401 (alternatively referred to herein as a “server”) that may be used in accordance with the principles of the invention. Server 401 may be included in a customer access device such as customer access device 202 (shown in FIG. 2), an account access control module such as account access control module 202 (shown in FIG. 2), or in any other suitable apparatus that is shown or described herein.

Server 401 may have a processor 403 for controlling overall operation of the server and its associated components, including RAM 405, ROM 407, input/output module 409, and memory 425.

Input/output (“I/O”) module 409 may include a microphone, keypad, touch screen, and/or stylus through which a user of device 401 may provide input, and may also include one or more of a speaker for providing audio output and a video display device for providing textual, audiovisual and/or graphical output. Software may be stored within memory 425 and/or storage to provide instructions to processor 403 for enabling server 401 to perform various functions. For example, memory 425 may store software used by server 401, such as an operating system 417, application programs 419, and an associated database 421. Alternatively, some or all of server 401 computer executable instructions may be embodied in hardware or firmware (not shown).

Server 401 may operate in a networked environment supporting connections to one or more remote computers, such as terminals 441 and 451. Terminals 441 and 451 may be personal computers or servers that include many or all of the elements described above relative to server 401. The network connections depicted in FIG. 4 include a local area network (LAN) 425 and a wide area network (WAN) 429, but may also include other networks. When used in a LAN networking environment, computer 401 is connected to LAN 425 through a network interface or adapter 423. When used in a WAN networking environment, server 401 may include a modem 427 or other means for establishing communications over WAN 429, such as Internet 431. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 419, which may be used by server 401, may include computer executable instructions for invoking user functionality related to communication, such as email, short message service (SMS), and voice input and speech recognition applications.

Computing device 401 and/or terminals 441 or 451 may also be mobile terminals including various other components, such as a battery, speaker, and antennas (not shown).

Terminal 451 and/or terminal 441 may be portable devices such as a laptop, cell phone, Blackberry™, or any other suitable device for storing, transmitting and/or transporting relevant information.

Any information described above in connection with database 421, and any other suitable information, may be stored in memory 425.

One or more of applications 119 may include one or more algorithms that may be used to transmit, receive, formulate or process account access control instructions and account access status information or any other suitable type of information, and/or perform any other suitable tasks related to account access control.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

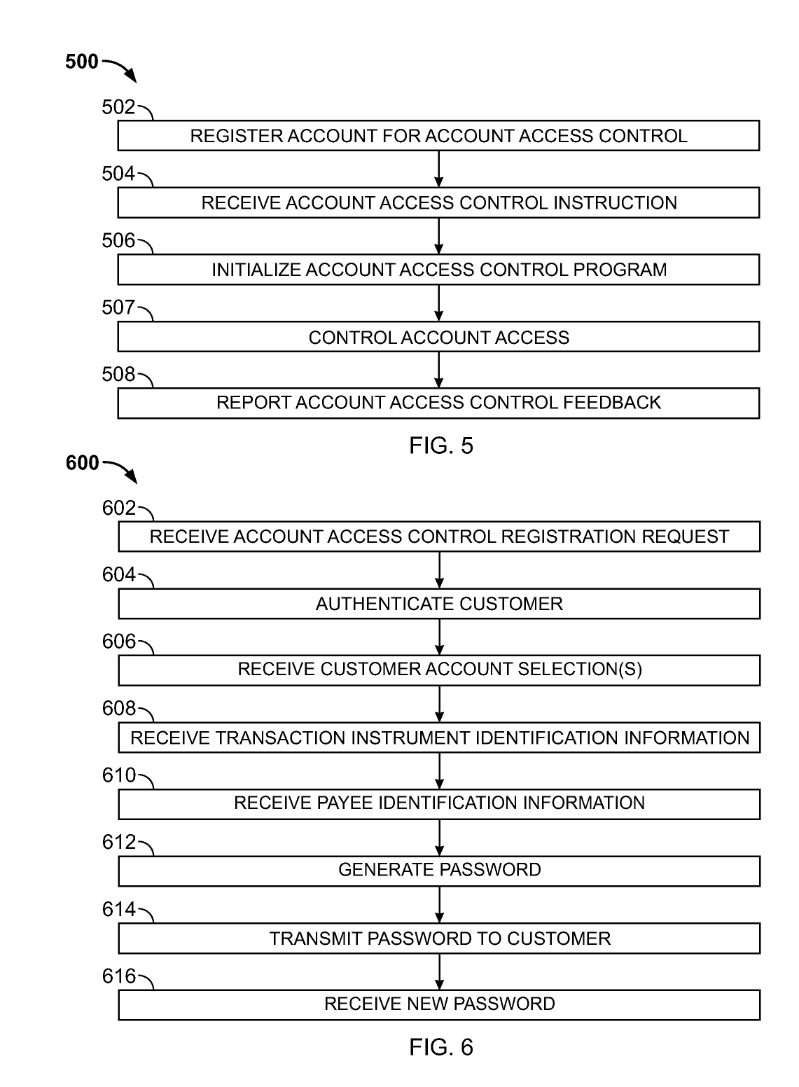

Processes in accordance with the principles of the invention may include one or more features of the processes illustrated in FIGS. 5-7. For the sake of illustration, the steps of the processes illustrated in FIG. 5-7 will be described as being performed by a “system.” The “system” may include one or more of the features of the apparatus that are shown in FIG. 2-4 and/or any other suitable device or approach. The “system” may be provided by an entity. The entity may be an individual, an organization or any other suitable entity.

FIG. 5 shows illustrative process 500 for controlling account access. Process 500 may begin at step 502. At step 502, the system may register an account for account access control. At step 504, the system may receive an account access control instruction. At step 506, the system may initialize an account access control program. At step 507, the system may control account access. At step 508, the system may report account access control feedback.

FIG. 6 shows illustrative process 600. The system may execute one or more of the steps of process 600 in connection with the execution of step 502 of process 500 (shown in FIG. 5).

Process 600 may begin at step 602. At step 602, the system may receive an account access control registration request. The request may be received from the customer. At step 604, the system may authenticate the customer. At step 606, the system may receive one or more customer account selections. The customer may identify to the system one or more customer accounts for which the customer desires account access control.

At step 608, the system may receive transaction instrument identification information. The system may receive the transaction identification information from the customer. The transaction instrument identification information may identify one or more transaction instruments that are associated with the account or accounts. At step 610, the system may receive payee identification information. The system may receive the payee identification information from the customer. The payee identification information may identify one or more payees that the customer selects for restriction or admission of transactions.

At step 612, the system may generate a password. The customer may use the password for authentication in connection with the issuance of account access control instructions. At step 614, the system may receive a new password. The system may receive the new password from the customer. The customer may select the new password and provide it to the system.

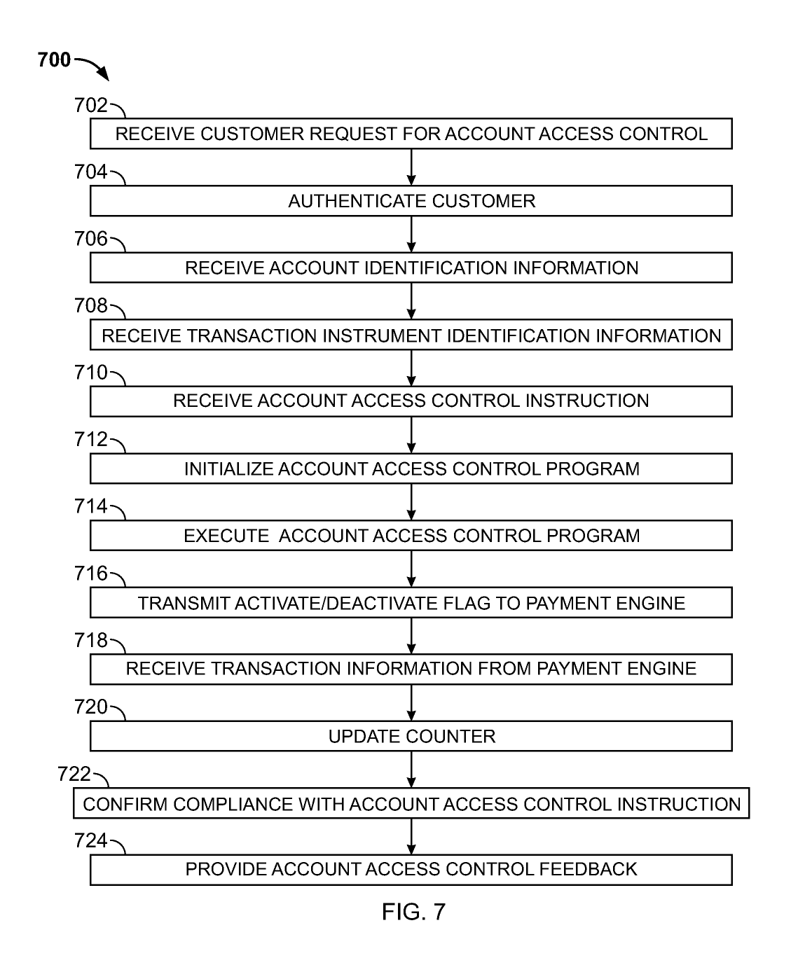

FIG. 7 shows illustrative process 700. The system may execute one or more of the steps of process 700 in connection with the execution of one or more of steps 504-508 of process 500 (shown in FIG. 5).

Process 700 may begin at step 702. At step 702, the system may receive a customer request for account access control. At step 704, the system may authenticate the customer's identity. The system may use a password such as those discussed in steps 612 and 614 of process 600 (shown in FIG. 6) to authenticate the customer's identity.

At step 706, the system may receive account identification information from the customer. The account identification information may identify an account for which the customer will issue an account access control instruction. At step 708, the system may receive transaction instrument identification information. The transaction instrument identification information may identify a transaction instrument for which the customer will issue an account access control instruction.

At step 712, the system may initialize an account access control program. The system may initialize the account access control program by storing an account access control instruction set in memory and identify rules that may be used by a processor to actively control account access in conformance with the account access control instruction set. At step 714, the system may execute the account access control program. The system may execute the account access control program by engaging the processor to transmit to an electronic payment engine ACTIVATE and DEACTIVATE flags in conformance with the requirements of the account access control instruction set. At step 716, the system may transmit one or more ACTIVATE flags and one or more DEACTIVATE flags to the electronic payment engine. The ACTIVATE and DEACTIVATE flags may restrict or allow transactions on the account to occur in accordance with the instruction set.

At step 718, the system may receive transaction information from the payment engine. The transaction information may include information about transactions or attempted transactions on the account. For example, the transaction information may include a transaction date, a transaction payee, a transaction amount and any other suitable transaction information.

The system may use the transaction information to condition, subject to the instruction set requirements, the issuance of ACTIVATE and DEACTIVATE flags. For example, the instruction set may allow a series of 3 transactions at a selected payee. The system may use transaction information to count the number of transactions at the selected payee that have occurred since the instruction set allowed the series.

The system may use the transaction information to check compliance of the payment engine with the instruction set. For example, the system may compare the identity of a transaction payee to the identity of a payee that is permitted by the instruction set.

At step 720, the system may update a counter. The counter may count a number of transactions that the system receives from the payment engine.

At step 722, the system may confirm compliance of the payment engine with the account access control instruction.

At step 724, the system may output account access control feedback. The system may transmit the account access control feedback to the customer. The account access control feedback may include account access control instruction information (such as current, default or previous account access control instructions or instruction sets or any other suitable account access control instruction information); account access control information (such as a counter value, payment engine compliance information or any other suitable account access control information); transaction information (such as a transaction date, a transaction payee, a transaction amount or any other transaction information) or any other suitable feedback.

One of ordinary skill in the art will appreciate that the elements shown and described herein may be performed in other than the recited order and that one or more elements illustrated may be optional. The methods of the above-referenced embodiments may involve the use of any suitable elements, elements, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, apparatus and methods for controlling account access have been provided. Persons skilled in the art will appreciate that the present invention can be practiced by other than the described embodiments, which are presented for purposes of illustration rather than of limitation. The present invention is limited only by the claims that follow.

What is claimed is:

1. Apparatus for controlling account access, the apparatus comprising:
a receiver that is configured to receive from a customer an account access control instruction that is configured to change an access status of an account that holds funds belonging to the customer, the customer being one of a plurality of customers of a financial institution, each of the customers owning funds that are held in different accounts; and
a processor that is configured to:
initialize an account access control program; and
change the access status of the account.

2. The apparatus of claim 2 further comprising a transmitter that is configured to change the access status by transmitting a data object to an electronic payment platform.

3. The apparatus of claim 1 further comprising a transmitter that is configured to transmit account access control feedback to the customer.

4. The apparatus of claim 1 wherein the account access control instruction includes an access switch.

5. The apparatus of claim 1 wherein the account access control instruction includes a temporal constraint.

6. The apparatus of claim 1 wherein the account access control instruction includes a check number.

7. The apparatus of claim 1 wherein the account access control instruction includes an amount.

8. One or more computer-readable media storing computer-executable instructions which, when executed by a processor on a computer system, perform a method for controlling account access, the method comprising:
receiving from a customer an account access control instruction that is configured to change an access status of an account that holds funds belonging to the customer, the customer being one of a plurality of customers of a financial institution, each of the customers owning funds that are held in different accounts;
initializing an account access control program; and
changing the access status of the account.

9. The media of claim 8 wherein, in the method, the changing includes transmitting a data object to an electronic payment platform.

10. The media of claim 8 wherein the method further comprises using a transmitter to transmit account access control feedback to the customer.

11. The media of claim 8 wherein, in the method, the account access control instruction includes an access switch.

12. The media of claim 8 wherein, in the method, the account access control instruction includes a temporal constraint.

13. The media of claim 8 wherein, in the method, the account access control instruction includes a check number.

14. The media of claim 8 wherein, in the method, the account access control instruction includes an amount.

15. A method for controlling account access, the method comprising:
using a receiver, receiving from a customer an account access control instruction that is configured to change an access status of an account that holds funds belonging to the customer, the customer being one of a plurality of customers of a financial institution, each of the customers owning funds that are held in different accounts; and
using a processor:
initializing an account access control program; and
changing the access status of the account.

16. The method of claim 15 wherein the changing includes transmitting a data object to an electronic payment platform.

17. The method of claim 15 further comprising using a transmitter to transmit account access control feedback to the customer.

18. The method of claim 15 wherein the account access control instruction includes an access switch.

19. The method of claim 15 wherein the account access control instruction includes a temporal constraint.

20. The method of claim 15 wherein the account access control instruction includes a payee constraint.

21. The method of claim 15 wherein the account access control instruction includes a check number.

22. The method of claim 15 wherein the account access control instruction includes an amount.
